(19) United States
(12) Patent Application Publication
(10) Pub. No.: US 2012/0020061 A1
(43) Pub. Date: Jan. 26, 2012

(54) POLE LIGHTS AND DOCK POLE COVERS WITH LIGHTING

(76) Inventors: Allen J. Schefers, Wayzata, MN (US); Douglas J. Reak, Crystal, MN (US)

(21) Appl. No.: 13/189,047

(22) Filed: Jul. 22, 2011

Related U.S. Application Data
(60) Provisional application No. 61/366,636, filed on Jul. 22, 2010.

(51) Int. Cl. F21L 4/00; B23P 11/00

(52) U.S. Cl. 362/183; 29/525.11

(57) ABSTRACT

The present invention is a self contained lighting system, including a light member, the light member having at least one light emitting member operably coupled to an ambient light sensor, the light sensor opening a path of electric energy to at least one light emitting member at a first certain sensed level of ambient light and closing the path of electric energy to at least one light emitting member at a second certain sensed level of ambient light, an electric energy storage device operably coupled to the path of electric energy and an electric energy generation device operably coupled to the electric energy storage device, the electric energy generation device for providing electric energy to the electric energy storage device, and a generally thin walled tube being operably coupled to the light member, the tube defining an inner aperture, an opening at the first end of the tube opening to the inner aperture, and at least one threaded, generally transverse bore defined in the thin wall, the at least one bore for threadedly receiving a set screw. A method of forming the self contained lighting system, is further included.

### RELATED APPLICATION INFORMATION

This application claims the benefit of U.S. Provisional Application 61/366,636, filed Jul. 22, 2010, which is hereby incorporated by reference.

### FIELD OF THE INVENTION

The present invention generally relates to the field of portable lighting, dock poles, more particularly, the present invention relates to lighting that may be affixed to a dock or impaled in the ground.

### BACKGROUND OF THE INVENTION

Inadequate lighting on walking paths remote from electrical power is a chronic and potentially serious safety hazard. It is often impractical to run electric power to remote areas; these remote areas may be as far as a camp site located miles away from a source of electric power or as close as the edges of one's own yard. Because these areas are without power, they are often unlit at night. This inadequate lighting can cause a number of safety hazards, the first and foremost being the increased chance of tripping over an unseen obstacle. For example, paths through wooded areas often traverse over exposed tree roots and rocks. These obstacles are trip hazards during the day when the path is well lighted; the potential for tripping is only increased at night. Worse yet, when these walkways are near, or even over water (as in the case of a lake or river dock), the risk of tripping poses the additional hazard of falling into the water at night and possibly drowning.

The absence of lighting on a dock also makes the location of the dock, or identification of the correct dock when multiple docks are present, difficult when approaching by boat at night. Most lake and river docks contain a number of spaced apart support or docking poles. These dock poles extend from the dock platform down to the bottom of the body of water. When boating, locating a dock from across a dark body of water, where only the unlit dock poles and platform extend above the water, can be a difficult task. Often the boater must approach the shore near the area of the dock before location of the dock is possible. When in close proximity to the shore, the shallow water poses the risk of damaging the boat by striking the hull or prop against sunken logs, rocks, or other obstacles.

Once the boater locates the dock, without adequate lighting there is an increased probability that the boater will misjudge the boundaries of the dock and collide with the dock. Although the speed of the boat prior to collision is not likely to be great, the sudden stop caused by the collision may cause passengers, particularly those who are standing, to fall and injure themselves. Moreover, the collision is likely to cause damage to the boat.

### SUMMARY OF THE INVENTION

The present invention addresses these hazards by providing a means to light previously unlit areas, remote from electric power, through a self-powered mobile safety light mounted to a multi-use pole. The invention consists of a solar-powered safety light which may be attached to a multitude of different utility poles. One embodiment of the utility pole allows the user to slip the utility pole over an existing dock pole so that if a self-powered safety light is positioned on each dock pole on the dock, the boundary of the dock would clearly be defined and the dock surface would be illuminated. Use of the present invention in this manner would reduce the chance of tripping on the dock and increase the viability and location of the dock at night by boat. Furthermore, because of the self-powered safety light is lightweight and easily portable. When finished boating, users may slip the self-powered safety light off the dock pole and carry it with them like a torch to provide lighting along their desired path.

The present invention is a self contained lighting system, including a light member, the light member having at least one light emitting member operably coupled to an ambient light sensor, the light sensor opening a path of electric energy to at least one light emitting member at a first certain sensed level of ambient light and closing the path of electric energy to at least one light emitting member at a second certain sensed level of ambient light, an electric energy storage device operably coupled to the path of electric energy and an electric energy generation device operably coupled to the electric energy storage device, the electric energy generation device for providing electric energy to the electric energy storage device, and a generally thin walled tube being operably coupled to the light member, the tube defining an inner aperture, an opening at the first end of the tube opening to the inner aperture, and at least one threaded, generally transverse bore defined in the thin wall, the at least one bore for threadedly receiving a set screw. A method of forming the self contained lighting system, is further included.

The utility pole may also be configured with a stake or pointed end, such that the user may stick the pole into the ground. This enables the user to provide fixed lighting for an area or path remote from electric power, thereby reducing the chances of tripping over unseen obstacles. Again, because of the ease in mobility of the safety light, if a user wishes to depart from the remote area, the user may simply remove the self-powered safety light from the ground and carry the light with them along their desired path. This highly adaptable configuration of the safety light's utility pole makes the light readily implantable wherever lighting is needed.

### BRIEF DESCRIPTION OF THE DRAWINGS

FIG. 1 is an exploded side elevation view of a dock pole cover with a self-powered mobile safety light in accordance with an embodiment of the invention;

FIG. 2 is a side elevation view of a dock pole cover with a self-powered mobile safety light in accordance with an embodiment of the invention;

FIG. 3 depicts a wiring harness to be used in conjunction with a with a low voltage version of the mobile safety light lighting in accordance with an embodiment of the invention;

FIG. 4 is a side elevation view of a self-powered mobile safety light configured on a telescoping pole with a pointed foot in accordance with an embodiment of the invention;

FIG. 5 is a side elevation view of a self-powered mobile safety light configured on a segmented pole assembly with a pointed foot in accordance with an embodiment of the invention;

FIG. 6 is a side elevation view of a self-powered mobile safety light configured with both a dock pole cover and pointed foot;

FIG. 7 depicts several dock pole covers with a self-powered mobile safety lights positioned on a lake or river dock during nighttime operation;

FIG. 8 is a side elevation view of self-powered mobile safety light configured with a dock pole cap.

### DETAILED DESCRIPTION OF THE INVENTION

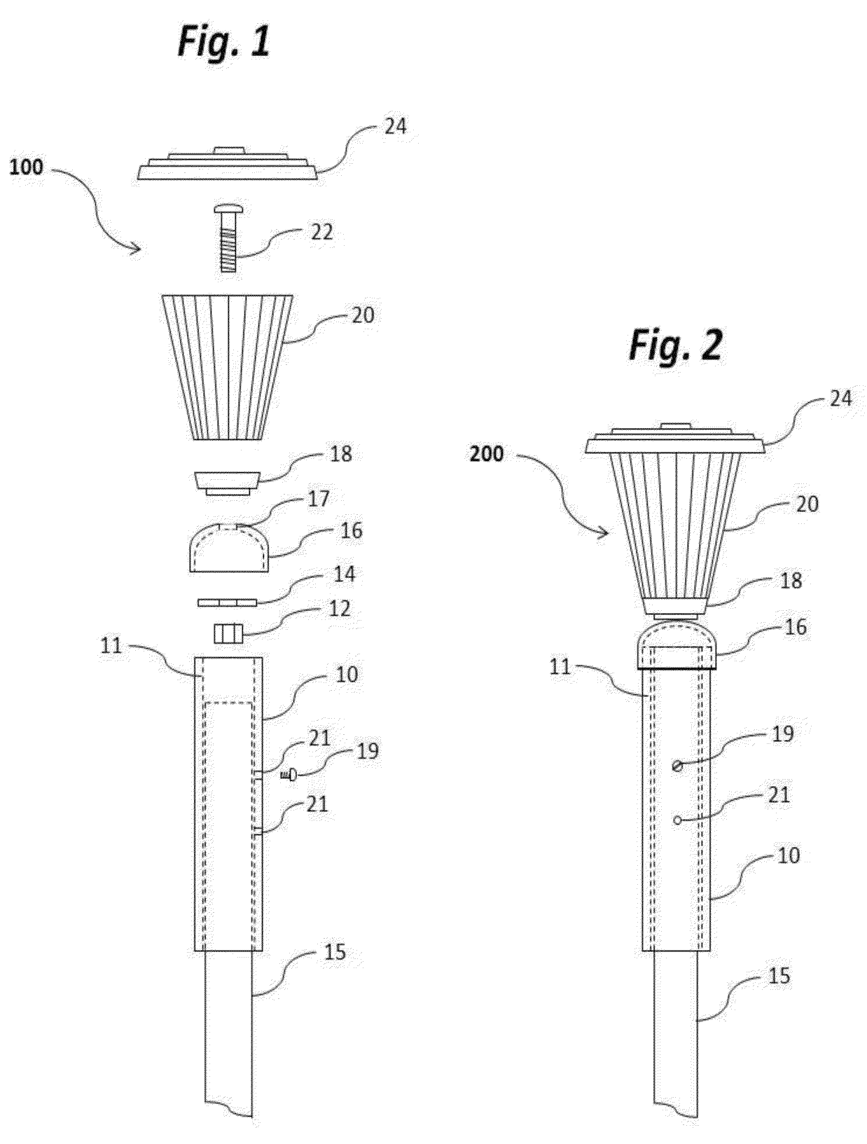

FIGS. 1 and 2 illustrate an embodiment of a dock pole cover with a self-powered mobile safety light 100 adapted to both cover an existing dock pole 15 and provide solar powered light. Dock pole cover with a self-powered mobile safety light 100 includes: pipe 10, set screw 19, nut 12, washer 14, cap 16, skirt 18, solar powered light 20, bolt 22, and top housing 24.

The inner diameter 11 of pipe 10 should be larger than the outer diameter of the existing dock pole 15, such that the assembled dock pole cover with a self-powered mobile safety light 200 may be slid onto, and fit over, an existing dock pole 15. As such, the assembled dock pole cover 200 serves as a boat bumper, minimizing damage to both the boat and the dock pole 15 when boats approach or are moored to the dock pole 15. Pipe 10 may consist of a segment of ultraviolet (UV) coated polyvinyl chloride (PVC) piping, as UV coated PVC piping generally is more durable and does not fade or yellow like regular PVC piping. This, however, should not be considered limiting; pipe 10 can be made from a variety of materials. To accommodate most dock poles 15, pipe 10 is typically generally thin walled and may consist of a section of standard size PVC pipe having a wall 11 with a nominal inside diameter of approximately 2 inches and an outside diameter of approximately 2.31 inches, yielding a wall thickness of 0.31 inches; however, a larger diameter pipe may be used to accommodate larger dock poles 15. Pipe 10 may be manufactured in lengths from 1 to 6 feet in length, although the length could be longer or shorter as necessary. Self-powered mobile safety light 200 can be secured in place when fitted over top the dock pole 15 by tightening set screw 19. Several threaded holes 21 are positioned longitudinally along pipe 10 to allow set screw to be selectively placed.

In one embodiment, the dock pole cover with a self-powered mobile safety light 100 is assembled by drilling hole 17 into cap 16. Cap 16 can consist of a standard UV coated PVC end cap appropriately sized to fit pipe 10; although the cap can also be constructed of a number of other suitable materials. The nominal drilled hole 17 will generally range from 0.5 to 2.12 inches in diameter; however, the hole can vary in size as necessary to accommodate skirt 18 and bolt 22. After hole 17 is drilled, skirt 18 and solar light 20 are placed on top of cap 16 and secured in place by bolt 22, washer 14, and nut 12. Bolt 22, washer 14, and nut 12 can be constructed of a variety of weather resistant materials, including, but not limited to plastic or stainless steel. Top housing 24 is fastened on top of solar light 20, typically either being glued in place or mating with integrated mechanical connectors within the respective components. Once skirt 18 and solar light 20 have been secured in place, cap 16 is then fitted on the top of pipe 10. A multitude of holes 21 are drilled in pipe 18 and threaded to accommodate set screw 19. Set screw 19 is partly screwed into one of the drilled holes 21 and left in place.

Solar light 20 houses solar light circuitry 900, as depicted as in FIG. 9. Solar light circuitry 900 is comprised of at least one light emitting member 124 operably coupled to an ambient light sensor 122. Light sensor 122 acts as both a light sensor and an on/off switch for light emitting member 124. Sensor 122 does this by opening a path of electric energy to light emitting member 124 at a first certain sensed level of ambient light and closing the path of electric energy to light emitting member 124 at a second certain sensed level of ambient light. Light emitting member 124 is operably coupled to and powered by an electric energy storage device 126. Electric energy storage 126 is operably couple to an electric energy generation device 120, which provides electric energy to the energy storage device 126. Solar light 20 containing solar light circuitry 900 is assumed to be commercially available. One example of this type of light is sold by Yard & Beyond®.

FIG. 8 shows and alternative configuration of the present invention 800 readily adaptable to fit over top dock pole 118. This embodiment 800 is constructed in a similar manner to the previous embodiment 200, but instead of having a dock pole cover pipe 10 this embodiment has only a coupler 116 affixed to the lighted assembly 112, where coupler 116 is appropriately sized to fit snuggly a top a standard sized lake or river dock pole 118. To fit snuggly over most standard sized dock poles 118, the inner diameter of coupler 112 can measure 2 5/16 inches; however, larger or smaller diameters may be used to accommodate other mounting poles.

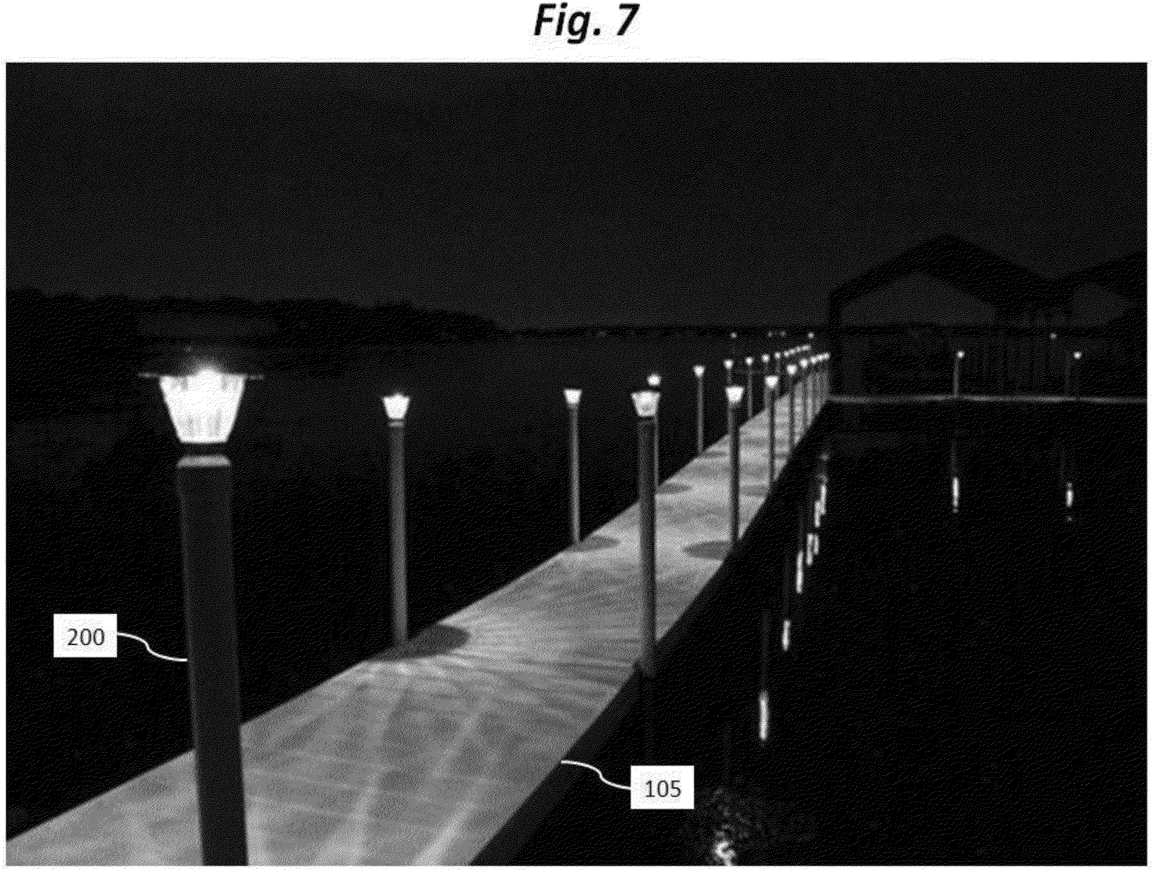

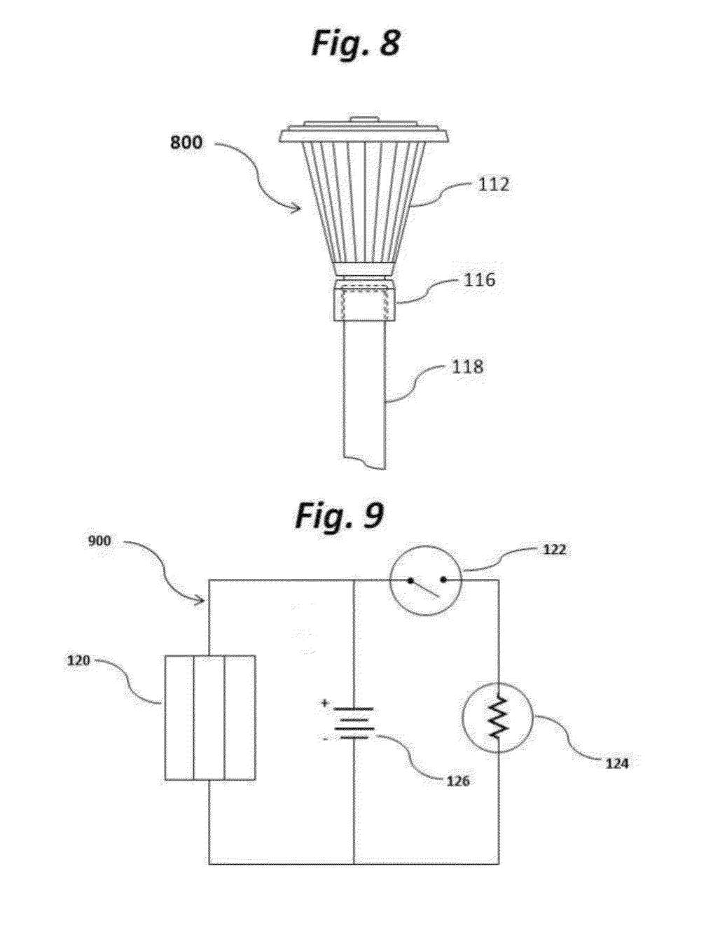

As depicted in FIG. 7, the esthetic effect of the employment of multiple self-powered mobile safety lights 200 on a dock 105 is enhanced by setting all the self-powered mobile safety lights 200 at a common height above the deck of the dock 105. This may be effected by the employment of a set screw 19. The set screw 19 is threadedly engaged in a respective threaded bore 21 defined in the wall 11. Multiple bores 21 may be defined in the wall 11 as desired and multiple set screws may thereby be employed. Once the self-powered mobile safety light 200 is adjusted to the desired height relative to the respective dock pole 15, one or more set screws are then turned in to engage the dock pole 15, thereby fixing the height of the respective self-powered mobile safety light 200.

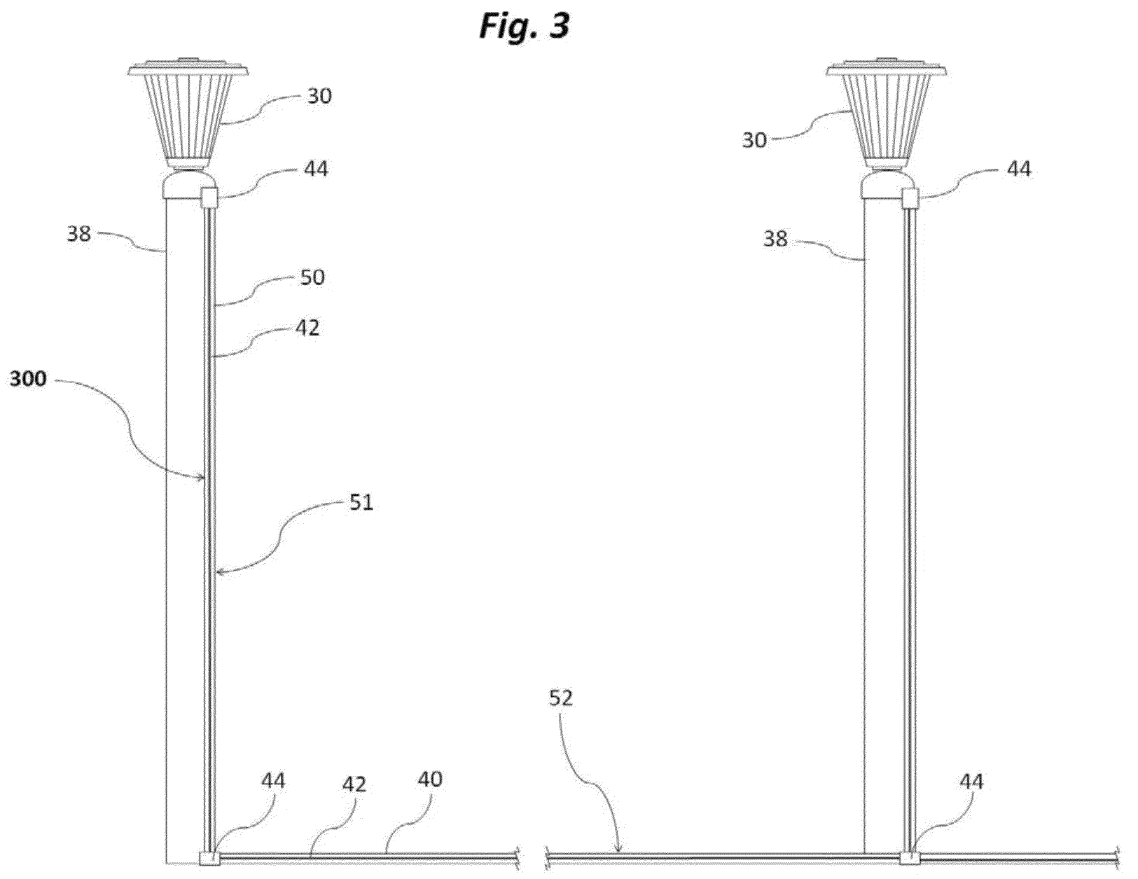

Referring to FIG. 3, a multitude of dock pole cover pipes 38 fitted with low voltage lights 30 can be connected via a wiring harness assembly 300. The low voltage light 30 is assembled together with pipe 38 in a similar manner to the previous embodiment 200; however, unlike the solar powered models, the individual low voltage lights 30 of embodiment 300 must be connected to an external power source. Wiring harness 300 fulfills this need while protecting the wire from exposure in an attractive housing. Wiring harness assembly 300 includes: wire 42, wire shielding 40 and 50, and water proof connectors 44.

Wire 42, which electrically connects the individual low voltage lights 30 to external power, will typically consist of between 14 to 20 gauge standard electrical wire. Wire 42 may, however, be of a larger or smaller gauge as needed.

The wire shielding 40, encompassing wire 42, will typically be constructed of a weather resistant vinyl; however, a number of other materials may also be suitable. In FIG. 3, the wire 42 and wire shielding 40 assemblies are configured in two lengths: eight feet 52 and three feet 51. However, the depicted lengths should not be considered limiting, as these assembles may be configured in any length necessary to connect the individual lights 30.

The eight foot assembly 52 can be attached to the outer surface of the dock, while the three foot wiring assembly 51 can be attached to pipe 38. Both wiring assemblies 51 and 52 can be attached by an adhesive. To facilitate this, a double-side adhesive tape is applied to one surface of wiring assembly 51 and 52 with a removable covering protecting the outer side of the double-side tape for later use. When assembly 51 or 52 is ready to be installed by the user, the cover is peeled off; exposing the adhesive. Wiring assembly 51 or 52 is then pressed into place.

Waterproof connectors 44 attached to the end of the wiring assemblies 51 and 52, connecting them together. The waterproof connectors 44 can range from one to six inches in length; however other lengths can be constructed as needed.

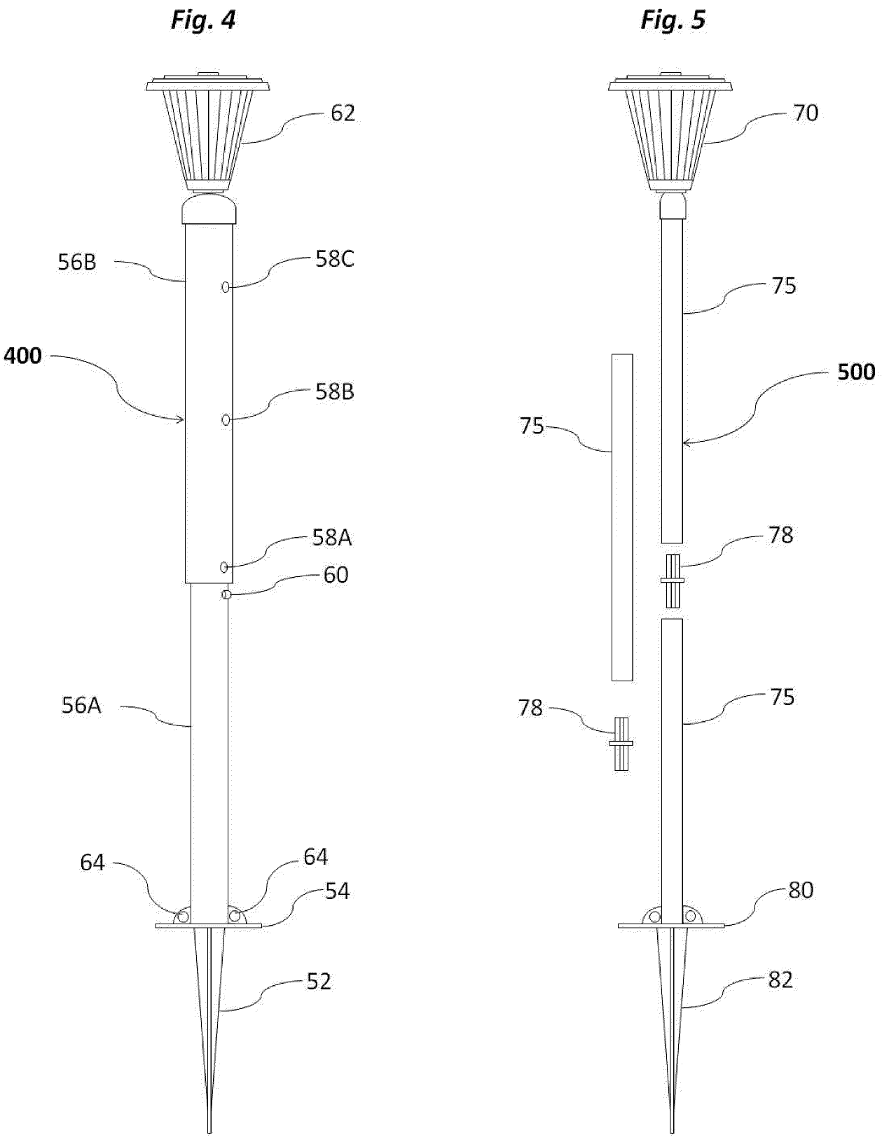

FIG. 4 illustrates an embodiment of the present invention in which a solar powered light is affixed to the top of a telescoping pole 400. The telescoping pole solar light assembly 400 includes: pointed foot 52, foot bracket 54, finger rings 64, telescoping metal poles 56A and 56B, holes 58A, 58B, and 58C, hole nib 60, and solar light assembly 62.

The extendable metal poles 56A and 56B can be constructed of a variety of materials, including, but not limited to aluminum tubing. The telescoping pole solar light assembly 400 depicts two poles 56A and 56B that are each two feet in length; however, there can be more than two poles, and each pole can vary in length. With a plurality of telescoping poles, each pole should be successively sized, both in diameter and length, to fit within the next larger sized pole. The largest pole can be positioned either closest to solar light assembly 62 or pointed foot 52. Holes 58A, 58B and 58C are placed along the length of the extended metal pole 56B to vary the height of telescoping pole assembly 400. A hole nib 60 is placed on pole 56A to lock pole 56B in place after the appropriate height for solar extended pole light 400 has been determined.

Pointed foot 52 and foot bracket 54 are secured to pole 56A using standard manufacturing techniques. Pointed foot 52 is approximately eight inches in length; however, pointed foot 52 can constructed to be significantly longer or shorter depending on the need. Foot bracket 54 can be used to push pointed foot 52 into the ground. Use of the foot bracket in this manner significantly reduces the compressive stress on the components of light assembly 400, thereby increasing component life. The foot bracket 54 can also be used to extract the pointed foot 52 from the ground. Finger rings 64 are provided for use as a grip during extraction.

Solar light 62 is mounted to pole 56B in a similar manner as previously described in connection with embodiment 200. Alternatively, a low voltage light, as described in connection with embodiment 300 can be attached to pole 56B.

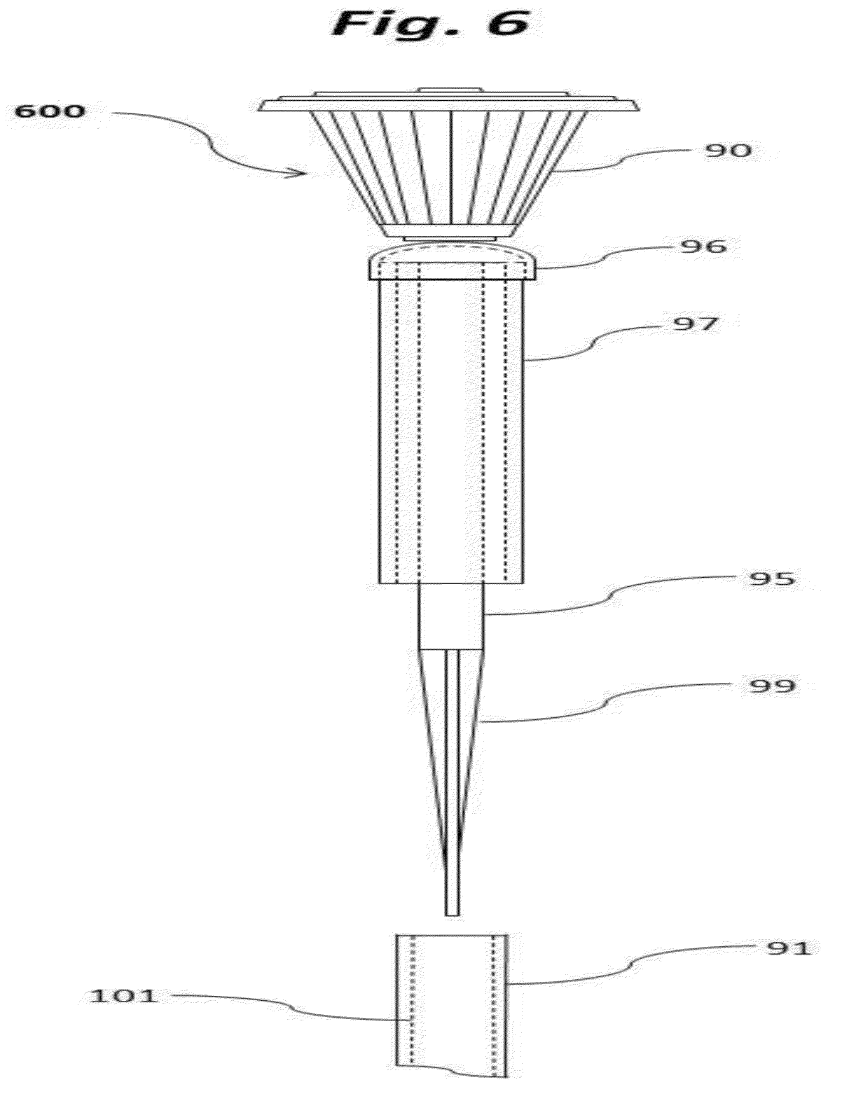

FIG. 5 illustrates an alternative embodiment 500, wherein the telescoping pole 56A and 56B of the previous embodiment 400 are replaced with a plurality of connectable pole segments 75. The segmented pole assembly 500 includes: a plurality of poles 75 and connectors 78. Poles 75 depicted in assembly 500 are each approximately two feet in length; however, each pole can vary in substantially length. The poles can be constructed of a variety of materials, including, but not limited to aluminum. The connectors 78 can be inserted approximately halfway into the open ends of each pole 75, fitting snuggly, such that poles 75 can be connected together to achieve the desired height. After use, the segmented pole assembly 500 can be disassembled for easy storage and transportation. Embodiment 500 is assembled together with solar light assembly 70, pointed foot 18, and foot plate 80 in substantially the same manner as described in connection with embodiment 400.

FIG. 6 illustrates an alternative embodiment 600, wherein in addition pipe 97 for covering dock pole 91, embodiment 600 also includes a inner pole 95 and pointed foot 99 sized such that pole 95 and pointed foot 99 fit within the inner diameter of 101 of dock pole 91. In this configuration, the dock pole cover with a self-powered mobile safety light 600 can be readily removed from a dock pole 91 and carried with a user the purpose of providing illumination. If the user so chooses, the self-powered mobile safety light 600 can be fixed to the ground via pointed foot 99. Embodiment 600 is assembled together with cap 96 and solar light assembly 90 in substantially the same manner as described in connection with embodiment 100.

Referring to FIG. 7, the dock pole cover with a self-powered mobile safety light 700, can be manufactured to the same height; thereby providing an aesthetically pleasing panorama of adequate lighting for users walking along the dock 105 or while approaching dock 105 via boat.

Various modifications and alterations of this invention will become apparent to those skilled in the art without departing from the scope and spirit of this invention, and it should be understood that this invention is not to be unduly limited to the illustrative embodiments set forth herein.

What is claimed is:

1. A self contained lighting system, comprising:
a. a light member, the light member having at least one light emitting member operably coupled to an ambient light sensor, the light sensor opening a path of electric energy to at least one light emitting member at a first certain sensed level of ambient light and closing the path of electric energy to at least one light emitting member at a second certain sensed level of ambient light, an electric energy storage device operably coupled to the path of electric energy and an electric energy generation device operably coupled to the electric energy storage device, the electric energy generation device for providing electric energy to the electric energy storage device, and
b. a generally thin walled tube being operably coupled to the light member, the tube defining an inner aperture, an opening at the first end of the tube opening to the inner aperture, and at least one threaded, generally transverse bore defined in the thin wall with at least one bore for threadedly receiving a set screw.

2. The self contained lighting system of claim 1, including an end cap that is on one side fitted to one end of the generally thin walled tube and on the opposing side operably coupled to the lighted member.

3. The self contained lighting system of claim 2, wherein both the thin walled tube and end cap are constructed of UV coated PVC piping.

4. The self contained lighting system of claim 1, including a generally pointed foot, having a received member oppositely disposed relative to a pointed foot, the receiving member for being selectively removable received within the opening and the inner aperture.

5. The self contained lighting system of claim 4, wherein there are a plurality of generally thin walled tubes, the outer diameter of all but the largest diameter tube successively sized to fit within the inner aperature of the next larger diameter tube, such that the tubes may operate in a telescoping fashion thereby causing the overall length of the thin walled tube assembly to be variable.

6. The self contained lighting system of claim 4, wherein there are a plurality of generally thin walled tubes which may be longitudinally connected, with one of the thin walled tubes being operably connected to the lighted member.

7. The self contained lighting system of claim 1, including a secondary tube sized to fit within the inner aperature of the generally thin walled tube, with one end of the secondary tube operably coupled to the lighted member, the opposing end of the secondary tube operably coupled to a generally pointed foot, and the generally pointed foot extending longitudinally beyond the first end of the generally thin walled tube opening.

8. A self contained lighting system, comprising:
a. a light member, the light member having at least one light emitting member operably coupled to an ambient light sensor, the light sensor opening a path of electric energy to at least one light emitting member at a first certain sensed level of ambient light and closing the path of electric energy to at least one light emitting member at a second certain sensed level of ambient light, an electric energy storage device operably coupled to the path of electric energy and an electric energy generation device operably coupled to the electric energy storage device, the electric energy generation device for providing electric energy to the electric energy storage device, and
b. a generally thin walled coupler operably coupled to the light member, distal to the light member coupling opening to a defined inner aperture, with the inner aperture measuring 2 5/16 inches in diameter.

9. A method for assembling of a self contained lighting system, comprising:
a. drilling a hole in a thin walled end cap;
b. securing a lighted member to the thin walled end cap with a nut and bolt, the bolt passing through the drilled hole in the end cap;
c. securing a cover to the top of the lighted member;
d. securing the thin walled cap to a section of thin walled tubing;
e. drilling a plurality of generally traverse holes laterally along the length of the thin walled tubing;
f. threading said plurality of generally traverse holes; and
f. screwing a set screw partly into one of threaded holes.
